(19) United States
(12) Patent Application Publication
(10) Pub. No.: US 2009/0088093 A1
(43) Pub. Date: Apr. 2, 2009

(54) Signal predistortion in radio transmitter

(75) Inventor: Markus Nentwig, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/984,398

(22) Filed: Nov. 16, 2007

(30) Foreign Application Priority Data
Oct. 1, 2007 (FI) 20075690

(51) Int. Cl. H04B 1/00

(52) U.S. Cl. 455/114.3

(57) ABSTRACT

A transmission signal to be transmitted from a radio transmitter is predistorted in order to compensate for the signal distortion caused by a power amplifier. The predistortion parameters for at least one of envelope and phase predistortion are selected according to the bandwidth of the transmission signal. Then, the transmission signal is predistorted with the selected predistortion parameters, and the predistorted transmission signal is power-amplified in the power amplifier for transmission

### FIELD OF THE INVENTION

The invention relates generally to radio transmitters and particularly to predistortion of a transmission signal before power amplification.

### BACKGROUND OF THE INVENTION

In radio transmitters, a transmission signal, i.e. the signal being transmitted, is amplified in a radio frequency power amplifier which amplifies the transmission signal to a level suitable for transmission over an air interface to a radio receiver. The level of the power-amplified transmission signal should be high enough to enable the radio receiver to decode information contained in the transmission signal.

Power amplifiers are not ideal components and thus power amplification does not result in an ideally power-amplified transmission signal. Instead, the power-amplified transmission signal is corrupted by amplitude and phase distortion caused by the power amplifier. If this distortion is not corrected before transmission or at the radio receiver, the decoding of the information will be hindered at the radio receiver. Additionally, the radio transmitter may produce undesired out-of-band emissions, thereby interfering other trans-ceivers operating on adjacent frequency channels.

The amplitude and phase distortion caused by the power amplifier may be compensated for by predistorting the transmission signal before the power amplification. One known transmission signal predistortion method monitors constantly the amplitude and phase distortion affected by the power amplifier. Accordingly, the solution comprises a feedback loop for the power-amplified transmission signal to enable measurement of the amplitude and phase distortion caused by the power amplifier. On the basis of the measured distortion values, predistortion values are calculated for the amplitude and phase of the transmission signal, and the transmission signal is predistorted with these predistortion values before power amplification. This solution ensures that the predistortion values are always up-to-date, but the solution requires an excessive amount of signal processing, which requires high computational capacity and consumes power. Both of these issues are critical in a mobile communication device which operates with a battery and is desired to be compact in size. Therefore, there is a need for simpler, yet efficient, predistortion solutions.

### BRIEF DESCRIPTION OF THE INVENTION

An object of the invention is to provide an improved solution for pre-distorting a transmission signal in order to overcome signal distortion caused by a power amplifier.

According to an aspect of the invention, there is provided a trans-mission signal predistortion method as described in claim 1.

According to another aspect of the invention, there is provided an apparatus as specified in claim 14.

According to another aspect of the invention, there is provided a radio transmitter as specified in claim 27.

According to another aspect of the invention, there is provided an apparatus as specified in claim 28.

According to another aspect of the invention, there is provided a computer program distribution medium readable by a computer and encoding a computer program of instructions for executing a computer process for trans-mission signal predistortion as specified in claim 29.

Preferred embodiments of the invention are defined in dependent claims.

### BRIEF DESCRIPTION OF THE DRAWINGS

In the following, the invention will be described in greater detail with reference to the embodiments and the accompanying drawings, in which

FIG. 1 is a block diagram illustrating components of a radio transmitter according to an embodiment of the invention;

FIG. 2 illustrates phase distortion properties of a power amplifier according to different bandwidths of a transmission signal;

FIG. 3 illustrates a transmission signal predistortion unit according to an embodiment of the invention;

FIGS. 4A and 4B illustrate amplitude and phase distortion lookup tables, respectively, for use in a transmission signal predistortion unit according to an embodiment of the invention;

FIGS. 5A and 5B illustrate amplitude and phase distortion lookup tables, respectively, for use in a transmission signal predistortion unit according to an embodiment of the invention;

FIG. 6 illustrates a transmission signal predistortion unit according to another embodiment of the invention;

FIG. 7 illustrates a transmission signal predistortion unit according to still another embodiment of the invention;

FIG. 8 is a block diagram illustrating components of a radio transmitter according to another embodiment of the invention;

FIG. 9 illustrates a block diagram of a predistortion unit for use in the radio transmitter of FIG. 8; and

FIG. 10 is a flow diagram illustrating a process according to an embodiment of the invention for predistorting a transmission signal before power amplification.

### DESCRIPTION OF EMBODIMENTS

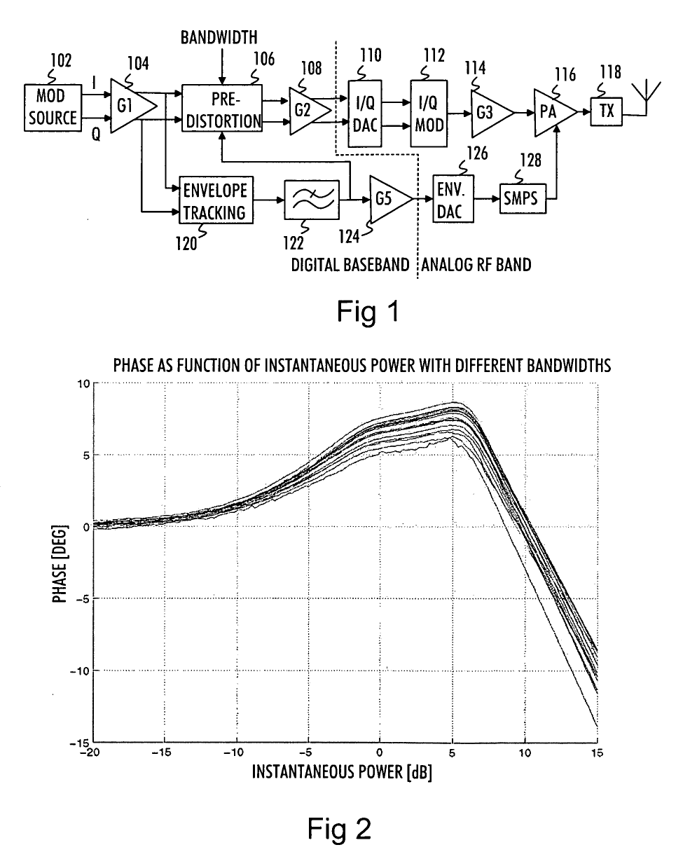

FIG. 1 is a block diagram illustrating components of a radio transmitter according to an embodiment of the invention. The radio transmitter may be a mobile communication device, for example. The block diagram of FIG. 1 illustrates components related to predistortion and power amplification of a transmission signal. All of the components illustrated in FIG. 1 are obviously not necessary for carrying out the invention.

In FIG. 1, a modulation source 102 provides a transmission signal comprising information symbols to be transmitted from the radio transmitter to a radio receiver. The transmission signal is in a digital form and divided into an in-phase (I) component and a quadrature (Q) component. The transmission signal is then fed to a first scaling circuit 104, which scales (amplifies) the transmission signal to a desired level suitable for an envelope tracking unit 120 and a predistortion unit 106. The envelope tracking unit 120 and the predistortion unit 106 may have certain requirements regarding the level of their corresponding input signals. For example, they may operate with a finite word length and, thus, require that the input signals have a level high enough to enable efficient use of the dynamic range of the units 106 and 120.

The envelope tracking unit 120 receives the I and Q component of the transmission signal as input signals and detects an envelope of the transmission signal from the I and Q component. From the envelope of the trans-mission signal, the envelope tracking unit 120 may derive a power supply control signal which is used for controlling a power supply voltage applied to a power amplifier 116. The envelope tracking unit 120 may include a filter which filters the power supply control signal which, may be configured to limit the fluctuation levels of the input signal between a given maximum and a minimum level. The invention is, however, not limited to the envelope tracking unit 120 described above and, therefore, utilization of other types of envelope (or amplitude) tracking units is possible for implementing the invention.

The envelope tracking unit 120 may output the filtered power supply control signal into a low-pass filter 122, which has a corner frequency lower than that of an envelope digital-to-analog (D/A) converter 126, and to a power supply signal generator 128 following the low-pass filter. By limiting the frequency band of the power supply control signal it is possible to improve the similarity between an output signal of the low-pass filter 122 and an output signal of the power supply signal generator 128. The similarity between these signals is an important feature when predistorting the transmission signal to compensate for distortion caused by the power amplifier. The low-pass filtered power supply control signal is then applied to the predistortion unit 106 and to a second scaling unit 124.

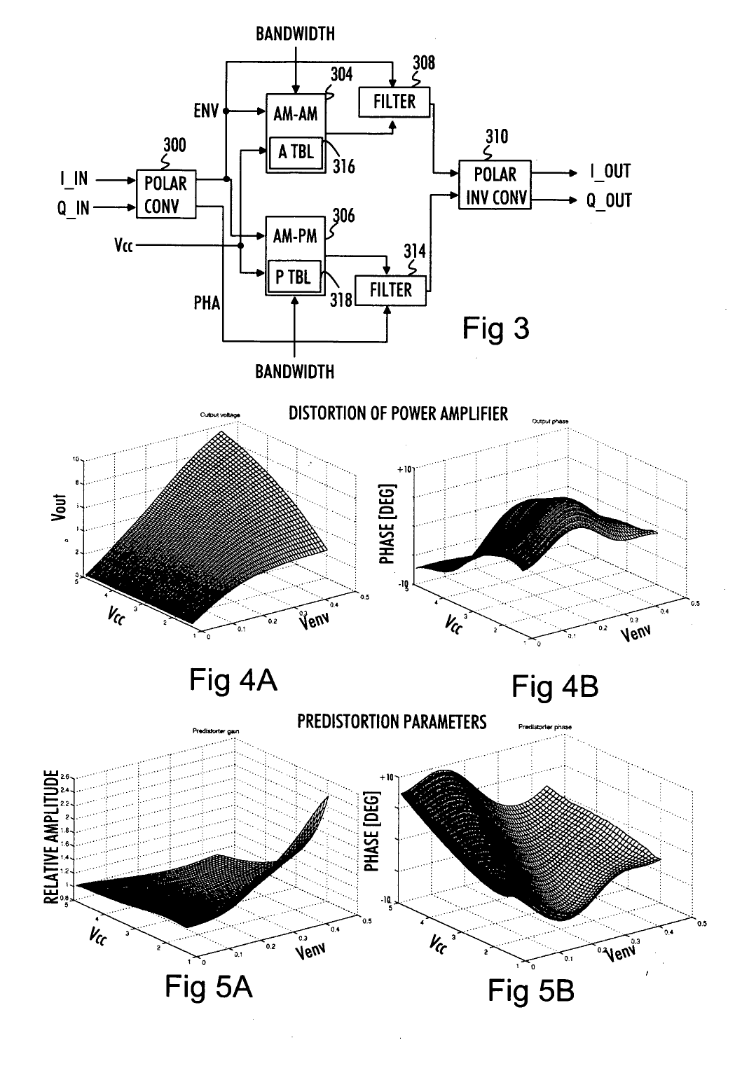

The predistortion unit 106 receives the scaled I and Q components of the transmission signal output from the first scaling unit 104 and the filtered power supply control signal output from the low-pass filter 122. Additionally, the predistortion unit 106 receives information on the bandwidth of the trans-mission signal. The bandwidth may be obtained from transmission parameters allocated to the radio transmitter for use in transmission of radio signals. Accordingly, there is necessarily no need to measure or estimate the bandwidth from the transmission signal. The predistortion unit 106 may use the filtered power supply control signal as a signal modeling a power supply voltage applied to the power amplifier 116. The predistortion unit 106 may have knowledge on the amplitude and phase distortion properties of the power amplifier 116 and it may predistort the transmission signal (I and Q component) to compensate for the distortion caused by the power amplifier 116. The operation of the predistortion unit 106 will be described in detail with reference to FIGS. 3 to 7. The predistortion unit 106 outputs the predistorted transmission signal into a third scaling unit 108.

The third scaling unit 108 scales the predistorted transmission signal to a level suitable for an I/Q D/A converter 110. Accordingly, the third scaling unit 108 may scale the input signal to a level at which the dynamic range of the I/Q D/A converter 110 is efficiently utilized. The I/Q D/A converter 110 converts the digital I and Q components into analog signals and feeds them to an I/Q modulator 112. The I/Q modulator 112 converts the baseband analog I and Q components of the transmission signal into a radio frequency (RF) transmission signal. In other words, the I/Q modulator 112 modulates a carrier signal according to the information contained in the I or Q component of the trans-mission signal. A separate carrier is modulated for each I and Q component and a phase shift between the two carriers is typically 90 degrees. The carriers are then summed together to provide the RF transmission signal.

The RF transmission signal is then fed to an amplifier 114, which may amplify the RF transmission signal to a level suitable for power amplification. Depending on the absolute value of the desired transmitted power at the output of power amplifier 116, the gain of the third scaling unit (a digital amplifier) 108 and the gain of the analog amplifier 114 can be varied, keeping the total gain contribution to the signal by both amplifiers constant. For example, if the absolute desired transmitted power at the output of power amplifier 116 is low, the gain of the third scaling unit 108 can be increased by a given amount and the gain of the amplifier 114 reduced by the same amount to operate the D/A converter 110 at a signal level sufficiently above the noise floor of the D/A converter 110.

The power amplifier 116 receives a power supply voltage from a power supply voltage generator 128, which may be a switched-mode power supply (SMPS), for example. The power supply voltage provided by the power supply voltage generator 128 is controlled by the power supply control signal provided by the envelope tracking unit 120. As mentioned above, the power supply control signal is filtered by the low-pass filter 122 which feeds the filtered power supply control signal to the fourth scaling unit 124. The fourth scaling unit 124 scales the filtered power supply control signal to an operational range of an envelope D/A converter 126 which converts the digital power supply control signal into an analog form suitable for inputting to the power supply voltage generator 128. The power supply voltage generator 128 then outputs a power supply voltage corresponding to the input control signal.

The power amplifier 116 then amplifies the transmission signal according to the power supply voltage provided by the power supply voltage generator 128 and applies the power-amplified transmission signal to RF front-end components 118 for transmission through an antenna, for example.

The purpose of controlling the power supply voltage according to the envelope of the transmission signal is to improve the efficiency of the power amplifier. In other words, the purpose is to provide the power amplifier enough power supply voltage to prevent clipping of the transmission signal, but not too much in order to prevent excessive power consumption in the radio transmitter.

Elements processing digital baseband signals according to FIG. 1 may be implemented in one or more processing units configured by suitable software, application-specific integrated circuits (ASICs), and/or as separate logic circuits, for example. In other words, units 102 to 110 and 120 to 126 may be implemented in such manner. The I/Q modulator 112, amplifier 114, and power amplifier 116 may also be embodied on ASICs.

It has been discovered that the distortion properties of the power amplifier are a function of the bandwidth of the transmission signal. The power amplifier has a memory effect which affects particularly phase distortion properties of the power amplification. FIG. 2 illustrates the phase distortion properties of the power amplifier as a function of instantaneous power of the power-amplified transmission signal. Each curve in FIG. 2 illustrates a different bandwidth of the transmission signal. The lowest curve represents a transmission signal having bandwidth of 180 kHz while the uppermost curve represents a transmission signal having bandwidth of 4.5 MHz. As becomes obvious from FIG. 2, the phase distortion properties of the power amplifier clearly change as a function of the bandwidth of the transmission signal, and this change in phase distortion should be taken into account in the predistortion of the trans-mission signal.

Next, operation of the predistortion unit 106 according to an embodiment of the invention will be described with reference to FIG. 3. As mentioned above, the predistortion unit 106 receives the transmission signal (I and Q component) I_IN and Q_IN, signal Vcc modeling the power supply voltage applied to the power amplifier 116, and the bandwidth of the transmission signal as input signals. The received transmission signal comprising the I component I_IN and the Q component Q_IN is converted into an envelope component ENV and a phase component PHA in a polar converter 300. Accordingly, the polar converter 300 may perform a rectangular-to-polar conversion. The envelope signal ENV is then fed to an envelope predistortion filter 308, an envelope predistortion parameter selection unit 304, and a phase predistortion parameter selection unit 306.

The envelope predistortion parameter selection unit 304 receives the envelope signal ENV and the signal Vcc modeling the power supply voltage as input signals. The envelope predistortion parameter selection unit 304 may comprise an amplitude distortion lookup table 316 containing information on amplitude distortion properties of the power amplifier 116. For example, the amplitude distortion lookup table 316 may comprise output voltage values of the power amplifier 116 as a function of an input signal voltage and the power supply signal voltage. As a consequence, the amplitude distortion lookup table 316 may represent the output voltage of the power amplifier 116 as the function of the level of the transmission signal (amplitude or envelope value) and the power supply signal voltage. Alternatively, power values of the transmission signal and the power supply signal may be used as indices in the lookup table. Alternatively, the amplitude distortion lookup table 316 may include pre-distortion values calculated beforehand from the amplitude distortion properties of the power amplifier. The amplitude distortion lookup table 316 may also represent the predistortion values as the function of the level of the transmission signal (amplitude or envelope value) and the power supply signal voltage (or as a function of power values).

The amplitude distortion lookup table 316 may have the form illustrated in FIG. 4A or 5A. FIG. 4A illustrates the amplitude distortion lookup table including the amplitude distortion values of the power amplifier, while FIG. 5A illustrates the amplitude distortion lookup table including the envelope predistortion values calculated from the amplitude predistortion properties of the power amplifier. In FIGS. 4A and 5A, Venv represents the level of the envelope component ENV. The envelope predistortion parameter selection unit 304 may store a plurality of amplitude distortion lookup tables having the structure similar to that of the amplitude distortion lookup table illustrated in FIG. 4A, wherein each amplitude distortion lookup table is associated with a different bandwidth or bandwidth range of the transmission signal. The bandwidth range is to be understood to include a plurality of different bandwidths of the transmission signal, i.e. a given lookup table is to be used for a plurality of bandwidths.

The envelope predistortion parameter selection unit 304 may also receive bandwidth information informing of the bandwidth of the transmission signal. Accordingly, the envelope predistortion parameter selection unit 304 may first read the received bandwidth information and select an amplitude distortion lookup table corresponding to the read bandwidth information. Then, the envelope predistortion parameter selection unit 304 may check the selected amplitude distortion lookup table in order to map the combination of the voltage levels of the input envelope signal ENV and the signal modeling the power supply voltage into a given output signal determined from the amplitude distortion lookup table 316 and output the output signal to the predistortion filter 308. The output signal of the envelope predistortion parameter selection unit 304 may define the predistortion parameters for the transmission signal or the amplitude distortion information of the power amplifier. In the first case where the envelope predistortion parameter selection unit 304 defines the predistortion parameters, the envelope predistortion parameter selection unit 304 may first detect the amplitude distortion properties of the power amplifier from the selected lookup table (FIG. 4A) and then calculate predistortion parameters that compensate for the detected distortion, or read the predistortion parameters directly from a lookup table (FIG. 5A) including precalculated predistortion parameters. In the latter case where the envelope predistortion parameter selection unit 304 defines the amplitude distortion information of the power amplifier, the envelope predistortion parameter selection unit 304 may simply perform the lookup (from FIG. 4A) and output the distortion properties of the power amplifier, and the actual predistortion parameter calculation is carried out in the envelope predistortion filter 308.

The envelope predistortion filter 308 may filter the envelope signal according to the signal received from the envelope predistortion parameter selection unit 304. In an embodiment, the envelope predistortion filter 308 is a divider configured to divide the input envelope signal ENV by the signal received from the envelope predistortion parameter selection unit 304. In another embodiment, the envelope predistortion filter 308 is a linear filter receiving filtering parameters from the envelope predistortion parameter selection unit 304. In general, term predistortion filter is here considered to include signal processing devices configured to modify their input signals, e.g. digital filters, multipliers, dividers, subtractors, adders.

The phase component PHA of the received transmission signal is predistorted in a phase predistortion filter 314, which may filter the phase component PHA of the transmission signal according to a control signal received from a phase predistortion parameter selection unit 306. The phase predistortion parameter selection unit 306 may function in a manner similar to the envelope predistortion parameter selection unit 304. The phase predistortion parameter selection unit 306 may comprise a plurality of phase distortion lookup tables 318 containing information related to phase distortion properties of the power amplifier 116, wherein each phase distortion lookup table is associated with a different bandwidth or bandwidth range of the transmission signal. In more detail, each phase distortion lookup table 318 may comprise output phase values of the power amplifier 116 as a function of the level of the trans-mission signal and the power supply signal voltage. As a consequence, the phase distortion lookup table 318 may represent the phase change introduced by the power amplifier 116 as the function of the transmission signal voltage (envelope value) and the power supply signal voltage. The phase distortion lookup table 318 may have the form illustrated in FIG. 4B or 5B. The lookup table of FIG. 4B includes the phase distortion properties of the power amplifier, while the lookup table of FIG. 5B includes precalculated phase predistortion parameters. Accordingly, the phase predistortion parameter selection unit 306 may first read received information on the bandwidth of the transmission signal and select a phase distortion lookup table corresponding to the bandwidth of the transmission signal. Then, the phase predistortion parameter selection unit 306 may check the selected phase distortion lookup table in order to map the combination of the voltage levels of the input envelope signal ENV and the signal Vcc modeling the power supply voltage into output phase values and output the output phase values to the phase predistortion filter 314. As was the case with the envelope predistortion, the output phase values of the phase predistortion parameter selection unit 306 may define the phase predistortion parameters for the transmission signal or the phase distortion information of the power amplifier. In the first case where the phase predistortion parameter selection unit 306 defines the predistortion parameters, the phase predistortion parameter selection unit 306 may first detect the phase distortion properties of the power amplifier from the selected lookup table (FIG. 4B) and then calculate phase predistortion parameters that compensate for the detected distortion, or read the predistortion parameters directly from a lookup table (FIG. 5B) including precalculated phase predistortion parameters. In the latter case where the phase predistortion parameter selection unit 306 defines the phase distortion information of the power amplifier, the phase predistortion parameter selection unit 306 may perform the lookup (from FIG. 4B) and output the phase distortion properties of the power amplifier, and the actual predistortion parameter calculation is carried out in the phase predistortion filter 314. The phase predistortion filter 314 then filters the phase component PHA of the transmission signal under the control of the output phase values of the phase predistortion parameter selection unit 306.

In an embodiment, the phase predistortion filter 314 is a subtracter configured to subtract the output phase values of the phase predistortion parameter selection unit 306 from the phase component PHA of the transmission signal. Actually, the phase distortion lookup table 318 may comprise values indicating the amount of phase distortion the power amplifier adds to its input signal. Accordingly, the amount of phase distortion is then removed from the phase component of the transmission signal beforehand. In another embodiment, the phase predistortion filter 314 includes a linear filter receiving filtering parameters from the phase predistortion parameter selection unit 306.

The predistorted phase component of the transmission signal, i.e. the output of the phase predistortion filter 314, is then fed to an inverse conversion unit 310 together with the predistorted envelope component of the transmission signal output from the envelope predistortion filter 308. The pre-distorted envelope component may be synchronized with the predistorted phase component to compensate for differences in delays between the envelope predistortion branch and the phase predistortion branch. The inverse conversion unit 310 then converts the predistorted envelope component and the predistorted phase component PHA into an in-phase component and a quadrature component containing envelope and phase predistortion. As a consequence, the inverse conversion unit 310 outputs a predistorted in-phase component and a predistorted quadrature component of the transmission signal.

In an embodiment, the amplitude and phase distortion lookup tables 316 and 318 for different bandwidths or bandwidth ranges may have been calculated at the development or production phase of the radio transmitter and stored in a memory unit of the radio transmitter. Accordingly, the information (the values) in the amplitude and the phase distortion lookup tables 316 and 318 is obtained beforehand and remains substantially fixed over time during the operation of the radio transmitter. Accordingly, there is no need to constantly monitor the distortion properties of the power amplifier 116 during the transmission. This simplifies the operation of the radio transmitter significantly and reduces power consumption.

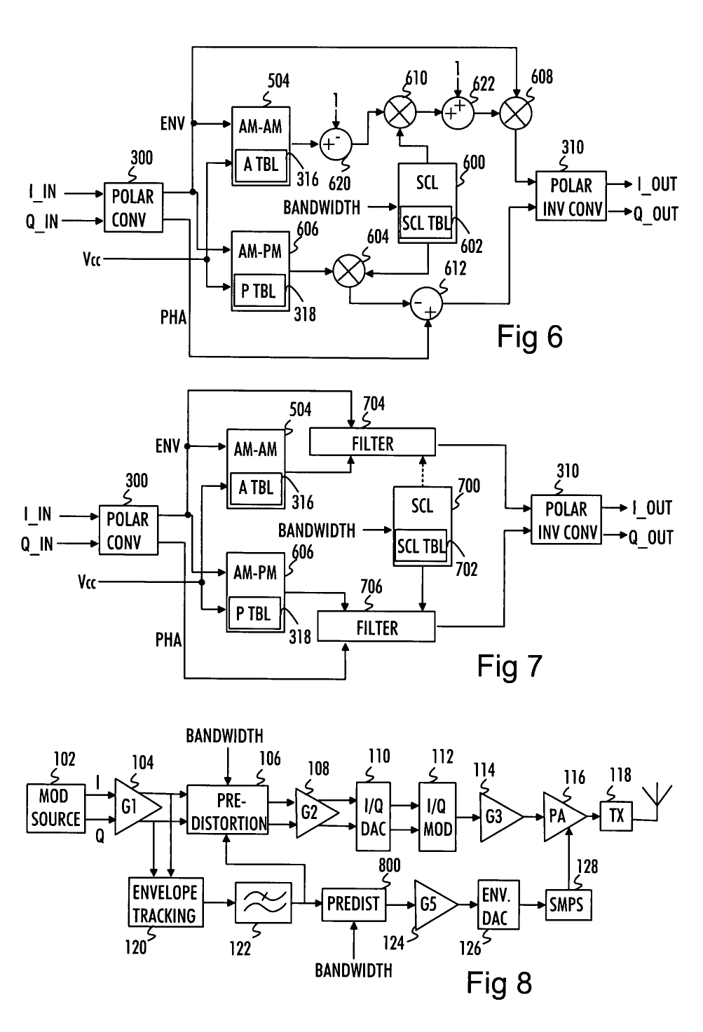

FIG. 6 illustrates another embodiment of the invention. Elements of FIG. 6 having the same reference numerals as those in FIG. 3 have the same functionality and, therefore, they will not be described herein in greater detail. In the embodiment of FIG. 6, both amplitude parameter selection unit 504 and phase parameter selection unit 606 include only a single amplitude distortion lookup table 316 and phase distortion lookup table 318, respectively. The contents of the distortion lookup tables 316 and 318 may be obtained beforehand and associated with a determined bandwidth of the transmission signal. In other words, the contents of the distortion lookup tables 316 and 318 may show envelope and phase distortion caused by the power amplifier when a transmission signal having the determined bandwidth is input to the power amplifier. The amplitude parameter selection unit 504 and the phase parameter selection unit 606 may function in a way similar to those described above with reference to FIG. 3 except for that they have only a single lookup table.

This embodiment includes a scaling unit 600 configured to select scaling values for the outputs of the amplitude parameter selection unit 504 and the phase parameter selection unit 606 on the basis of the received bandwidth information. In other words, the scaling unit 600 receives the bandwidth information and reads from a scaling lookup table 602 an envelope scaling value and a phase scaling value corresponding to the received bandwidth information and outputs the envelope scaling value to a first multiplier 610 and the phase scaling value to a second multiplier 604. The predistortion unit comprises a subtraction unit 620 configured to subtract the predistortion parameter value received from the envelope predistortion parameter selection unit 504 by one and output the subtracted predistortion parameter value to the first multiplier 610. The first multiplier 610 multiplies the subtracted predistortion parameter value by the envelope scaling value received from the scaling unit 600 and outputs the scaled envelope predistortion parameter value to a summation unit 622 configured to sum the scaled envelope predistortion parameter value with value “one” to compensate for the subtraction performed by the subtraction unit 620. The output of the summation unit 622 is fed to a third multiplier 608. In this embodiment, the envelope predistortion filter is implemented by the third multiplier 608, but the third multiplier 608 may be replaced by another filter structure. The third multiplier 608 performs the envelope predistortion by multiplying the envelope component ENV of the transmission signal by the scaled envelope predistortion parameter value received from the first multiplier 610 through the summation unit 622.

Correspondingly, the second multiplier 604 multiplies the phase scaling value received from the scaling unit 600 with the phase predistortion parameter value received from the phase predistortion parameter selection unit 606 and outputs the scaled phase predistortion parameter value to a subtracter 612. In this embodiment, the phase predistortion filter is implemented by the subtracter 612, but the subtracter 612 may be replaced or augmented by another filter structure. The subtracter 612 performs the phase predistortion by subtracting from the phase component PHA of the transmission signal the scaled phase predistortion parameter value received from the second multiplier 604. Then, the third multiplier 608 and the subtracter 612 output the scaled and predistorted envelope and phase components to the inverse conversion unit 310.

In this embodiment, the predistortion parameters are scaled on the basis of the amplitude and phase distortion properties of the power amplifier when power-amplifying a signal having a determined bandwidth. The scaling is performed before the actual predistortion. The envelope and phase scaling values may be stored into the scaling lookup table 602 as the function of the bandwidth of the transmission signal. In fact, the envelope and phase scaling values define the amount of increase or decrease in the predistortion according to the bandwidth of the transmission signal. As an example, let us assume that the parameter values output from a given predistortion parameter selection unit have a determined range. The scaling values output from the scaling unit 600 actually increase or decrease (or keep it at original range in case the scaling value is one) this range as the function of the bandwidth.

In this embodiment, the scaling unit 600 may output a coefficient defining the change in the range of the values output from the envelope predistortion parameter selection unit. In such case, the output values of the envelope predistortion parameter selection unit 504 may have to be preprocessed so that the range is actually changed by the degree defined by the coefficient. Let us assume that the output values of the envelope predistortion parameter selection unit range from 0.8 to 1.2, and this range should be doubled to range from 0.6 to 1.4 to double the predistortion. Accordingly, the scaling unit 600 outputs a coefficient having value of two. In such case, the output values of the envelope predistortion parameter selection unit 504 may be subtracted by one before the first multiplier 610. This may be performed by the subtraction unit 620, or it may be performed in the envelope predistortion parameter selection unit 504, in which case the subtraction unit 620 may be omitted. Then, the subtracted values are multiplied by the coefficient output from the scaling unit 600 in the first multiplier 610. The subtraction by one may be corrected by the summation unit 622 arranged between the first multiplier 610 and the third multiplier 608. The summation unit 622 may add one to the scaled values output from the first multiplier 610.

The envelope and phase scaling values may be stored into the scaling lookup table 602 in the production or testing phase on the basis of measurements of the distortion properties of the power amplifier with different bandwidths of power-amplified test signals.

FIG. 7 illustrates still another embodiment of the predistortion unit 106. In this embodiment, the scaling unit 700 inputs the scaling parameters read from the scaling value table 702 as a function of the bandwidth of the transmission signal directly as a control signal to the envelope and phase pre-distortion filters 704 and 706. In an embodiment, the scaling unit 700 inputs the scaling parameters only to the phase predistortion filter 706. This embodiment may also be applied to any other predistortion unit described above, i.e. the bandwidth of the transmission signal affects only the phase predistortion of the transmission signal. In some cases, the amplitude distortion of the power amplifier 116 does not change as a function of the bandwidth of the transmission signal. In such cases, the envelope predistortion as a function of the bandwidth is not necessary and may be omitted to reduce the complexity of the predistortion unit 106.

In the embodiment illustrated in FIG. 7, the envelope and phase predistortion filters 704 and 706 may include linear filters, and the scaling unit 700 may apply the scaling parameters to the predistortion filters 704 and 706 as transfer functions corresponding to the received bandwidth information. The phase predistortion filter 706 may additionally include a subtractor. The linear predistortion filters 704 and 706 may then modify their linearization parameters (calculated on the basis of the predistortion parameters received from the pre-distortion parameter selection units 504 and 606) according to the received transfer functions. The predistortion filters 704 and 706 may first filter the linearization parameters with the transfer function received from the scaling unit 700 and then predistort the transmission signal with the filtered linearization parameters. The actual phase predistortion may be carried out by the subtracter. In an embodiment, the transfer function is a polynomial or a linear function of the received bandwidth information. The coefficients of the polynomial and/or the linear function define the filtering coefficients to be used when filtering the linearization parameters.

Another embodiment may be applied to the case in which each pre-distortion parameter selection unit includes a plurality of distortion lookup tables associated with different bandwidths of the transmission signal. In other words, the predistortion parameter selection units 504 and 606 may be replaced by predistortion parameter selection units 304 and 306. The predistortion parameter selection units receive the bandwidth information, and select one or more distortion lookup tables according to the bandwidth of the trans-mission signal. The number of lookup tables stored in predistortion parameter selection units 504 and 606 may be smaller than the number of different possible bandwidths of the transmission signal. In such a case, the predistortion parameter selection units 504 and 606 may select predistortion parameters from one lookup table, if the bandwidth of the lookup table is the same as the received bandwidth information indicating the bandwidth of the transmission signal. If the received bandwidth information does not match with the bandwidth of any lookup table, the predistortion parameter selection unit may select predistortion parameters from at least two lookup tables having bandwidths closest to that of the transmission signal, and output the predistortion parameters to the predistortion filter.

The scaling unit 700 may provide the predistortion filters with information on how to weight the predistortion parameters obtained from the at least two different lookup tables. The predistortion filter may then weight the predistortion parameters received from the predistortion parameter selection unit according to the following equation:

y(W)=a(W)PP1+b(W)PP2 (1)

where W is a linear function of the bandwidth of the transmission signal, y is the result of the filtering operation, PP1 represents the predistortion parameters obtained from a first lookup table, PP2 represents the predistortion parameters obtained from a second lookup table, and a and b are weighting parameters provided by the scaling unit. In equation (1), it is assumed that the predistortion parameters selection unit provides predistortion parameters from two lookup tables, but the scheme may naturally be expanded to the case in which the predistortion parameters selection unit provides predistortion parameters from more than two lookup tables.

The weighting parameters a(W) and b(W) may be selected such that the filtering provides an interpolation between the predistortion parameters. The weighting parameters may be provided to give more weight to the predistortion parameters obtained from a lookup table associated with bandwidth closer to the bandwidth of the transmission signal and less weight to the predistortion parameters obtained from a lookup table associated with bandwidth further from the bandwidth of the transmission signal. In the case of linear interpolation, b(W) in equation (1) may be defined as b(W)=1−a(W).

In another embodiment, the scaling unit 700 configures the predistortion filter to select only one of the predistortion parameters provided by the predistortion parameter selection unit. To illustrate this case, the weighting parameters may include a step function u(W) such that a(W) and b(W) in equation (1) may be defined as a(W)=u(0.5−W) and b(W)=1−a(W). In other words, the scaling unit 700 configures the predistortion filter to select predistortion parameters associated with the bandwidth closer to the bandwidth of the trans-mission signal. The actual implementation may be arranged to use a function different from the step function, but the step function is used herein as an illustrative example.

Naturally, the above-mentioned embodiments may be applied to both envelope and phase predistortion.

The bandwidth information input to the predistortion unit 106 may be obtained by a processing unit of the radio transmitter from transmission parameters allocated for the transmission of the transmission signal. The radio transmitter may be configured for variable bandwidth transmission, i.e. the radio transmitter may be capable of changing the bandwidth of the transmission signal adaptively. The bandwidth may be determined according to radio channel environment, traffic in a radio system including the radio transmitter, etc. For example, the radio transmitter may be configured to transmit data according to an orthogonal frequency division multiplexing (OFDM) scheme, in which symbols are transmitted in a multicarrier signal including a plurality of subcarriers parallel in a frequency domain. The number of subcarriers allocated to the radio transmitter may be variable, thereby affecting the bandwidth of the transmission signal. Accordingly, the bandwidth information may include information on the number of subcarriers included in the transmission signal.

In many OFDM systems, a plurality of adjacent subcarriers are assigned to a resource block, and resource blocks are allocated to the radio transmitter instead of individual subcarrier in order to reduce signaling overhead. Accordingly, the number of resource blocks allocated to the radio transmitter may be variable, thereby affecting the bandwidth of the transmission signal. Accordingly, the bandwidth information may include information on the number of resource blocks included in the transmission signal.

The resource block may also be defined as a predetermined fixed bandwidth. Accordingly, the bandwidth allocated to the radio transmitter for transmission may be defined in terms of the number of resource blocks, and the radio transmitter may use the allocated resource blocks for transmission of one or more single carrier signals. A single carrier frequency division multiple access SC-FDMA is another example of an FDMA system, in which the radio transmitter is configured to use a bandwidth allocated to the radio transmitter to transmit a single carrier signal. The bandwidth allocated to the radio transmitter for transmission of the single carrier signal may be variable, and the bandwidth may be defined by a number of resource blocks, each having a pre-determined bandwidth.

In an embodiment, the radio transmitter may include a bandwidth detection unit configured to estimate a bandwidth of the transmission signal. The bandwidth detection unit may be included in the predistortion unit 106, but it may also be external to the predistortion unit 106. The bandwidth detection unit may estimate the bandwidth of the transmission signal before the predistortion unit (preferably at the input of the predistortion unit) and input the estimated bandwidth of the transmission signal to the predistortion unit 106 as the bandwidth information. The bandwidth of the transmission signal may be estimated by utilizing bandwidth estimation methods known in the art.

In an alternative embodiment, the bandwidth detection unit may be configured to estimate the bandwidth of the transmission signal at the output of the power amplifier and input the estimated bandwidth of the transmission signal to the predistortion unit 106 as the bandwidth information. In a further alternative embodiment, the bandwidth detection unit may be configured to estimate the bandwidth of the transmission signal by monitoring current consumption of the power amplifier and estimating the bandwidth from the monitored current consumption. Estimating the bandwidth from the monitored current consumption may be implemented by monitoring the time-varying current consumption of the power amplifier and by estimating the bandwidth based on statistical properties of the monitored time-varying current consumption. The statistical properties may include the spectrum of the current monitored consumption. In another embodiment, the bandwidth detection unit may be configured to use at least two of the above-mentioned bandwidth estimation methods, average the bandwidth estimates, and input the averaged bandwidth estimate to the predistortion unit 106.

The predistortion filters may include linear filters (or a single linear filter) configured to predistort the transmission signal according to a signal processing algorithm configuring the operation of the filter. Additionally, the phase predistortion filter may include the subtractor for the actual phase predistortion. The embodiments described above with reference to FIGS. 3 and 5 constitute a form of Hammerstein model for predistortion, i.e. Hammerstein predistorter. In the Hammerstein model, the lookup tables are located before the predistortion filter. Other possible solutions are Wiener model, wherein lookup tables are located after the linear predistortion filter, and Wiener-Hammerstein model, wherein lookup tables are located between two linear filters. Another embodiment includes a plurality of cascaded pairs including the lookup tables and a linear filter. The table-filter pairs may be formed according to the Hammerstein model, Wiener model, or Wiener-Hammerstein model. In the Wiener-Hammerstein model, each pair includes two filters and a lookup table between the filters, thus forming a group rather than a pair.

In the embodiment described above with reference to FIGS. 3 and 6, the envelope and phase distortion lookup tables are described as two-dimensional lookup tables having the envelope level of the transmission signal and the voltage of the signal modeling the power supply voltage as indices forming the two dimensions. Above with reference to FIG. 3, the bandwidth of the transmission signal was also described as an index used for selecting an appropriate lookup table. Alternatively, the bandwidth may be included as an index in the distortion lookup tables, thereby incorporating another dimension into the lookup tables. Other indices in the lookup tables may include temperature of the power amplifier, modulation scheme of the transmission signal, carrier frequency, among others. The predistortion unit 106 may obtain information on the modulation scheme from the transmission parameters allocated for transmission of the transmission signal. For the purpose of detecting the temperature of the power amplifier, the radio transmitter may include a temperature measurement unit including a sensor connected to the power amplifier 116 so as to measure the temperature of the power amplifier 116. The temperature measurement unit may then provide the predistortion unit 106 with information on the measured temperature of the power amplifier 116.

The predistortion unit 106 receives the information on the temperature of the power amplifier 116. Additionally, the predistortion unit 106 may receive the information on transmission parameters, such as the modulation scheme, the bandwidth, and other information needed for the selection of proper lookup tables. On the basis of this information, the predistortion unit 106 may select predistortion parameters corresponding to the received information from the amplitude distortion lookup table 316 and the phase distortion lookup table 318. The predistortion parameter selection units of the predistortion unit 106 may comprise logic to associate each combination of the transmission parameters, the temperature of the power amplifier 116 and other information with a given envelope distortion value and a given phase distortion value. In other words, the predistortion lookup tables may be stored as including distortion parameters of the power amplifier as a function of the above-mentioned parameters (temperature, transmission parameter combination, envelope level, and level of the power supply signal).

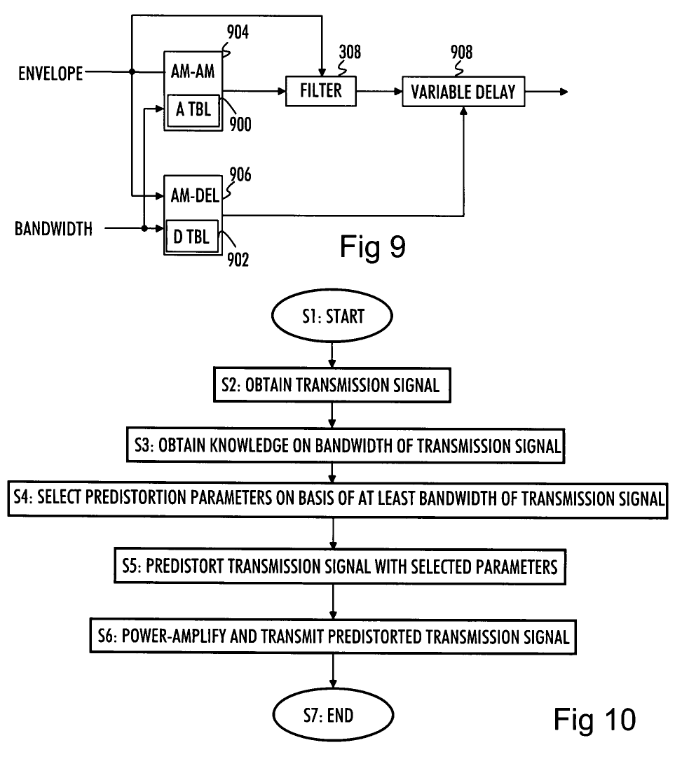

FIG. 8 illustrates an embodiment in which the power supply control signal is also predistorted in a second predistortion unit 800 arranged into the power supply control signal line in the radio transmitter. In the example illustrated in FIG. 8, the second predistortion unit 800 is located between the filter 122 and the scaling unit 124, but it may be located at any place in the power supply control signal line before the envelope D/A converter 126. The second predistortion unit 800 may have a structure illustrated in FIG. 9. The second predistortion unit 800 may include amplitude and delay predistortion parameter selection units 904 and 906 storing lookup tables for envelope and delay predistortion and selecting predistortion parameters for predistortion filters 308 and 908 configured to filter the power supply signal according to the selected predistortion parameters. In more detail, the amplitude and delay pre-distortion parameter selection units 904 and 906 may receive the envelope component received from the low-pass filter 122 and the bandwidth information as inputs. The operation of the amplitude parameter selection unit 904 may be similar to that described above with respect to FIG. 3. In other words, the envelope predistortion parameters are selected by searching the amplitude predistortion lookup table for a value corresponding to the input envelope and bandwidth information, determining the envelope predistortion parameters from the searched value, and outputting the determined envelope predistortion parameters to the envelope predistortion filter 308 configured to predistort the received envelope component.

Since a real-valued envelope signal is now processed in the predistortion unit 800 instead of the complex-valued signal processed in the embodiments described above, the phase predistortion parameter selection unit is now replaced by the delay predistortion parameter selection unit 906 storing the delay parameter lookup table 902. The delay predistortion parameter selection unit 906 may be configured to search the delay parameter lookup table 902 for a delay value corresponding to the received envelope and bandwidth information, to calculate delay predistortion parameters from the searched value, and to output the delay predistortion parameters to a delay predistortion filter 908. The delay predistortion filter 908 may be configured to delay the pre-distorted envelope signal output from the envelope predistortion filter 308 according to the delay parameters received from the delay predistortion parameter selection unit 906.

Parameters for the selection of the predistortion parameters, e.g. indices of the lookup tables 900 and 902, may include at least one of the following: the level of the input signal to the power supply signal generator, bandwidth of the transmission signal, bandwidth of the power supply signal. Other corresponding parameters disclosed above in conjunction with the transmission signal predistortion may also be used in the power supply signal predistortion.

In an embodiment, the delay predistortion filter described above may be a polyphase filter utilizing, for example, Farrow interpolation. The polyphase filter may receive the envelope component of the transmission signal and delay predistortion parameters as input signals and vary the delay of the envelope of the transmission signal according to the received delay predistortion parameters. The delay predistortion parameters may be input in the form of a variable delay. The polyphase filters and Farrow interpolation are commonly known in the art and will not be discussed herein in greater detail.

The predistortion unit illustrated in FIG. 9 is a modified version of the predistortion unit illustrated in FIG. 3. In alternative embodiments, the predistortion unit 800 may have a structure which is based on the predistortion unit illustrated in FIG. 6 or 7. In other words, the bandwidth-dependent scaling may be performed by the amplitude and delay predistortion parameter selection units or under control of a separate scaling unit.

The embodiment employing the predistortion in both main signal branch and power supply signal branch may also be applied to a polar transmitter structure or to Envelope Elimination and Restoration structure (EER). In the polar transmitter the transmission signal is divided into a phase-modulated component applied to the main signal branch and into an amplitude-modulated component applied to the power supply signal branch. Accordingly, a phase component predistortion unit may be provided in the main signal branch, and an amplitude component predistortion unit may be provided in the power supply signal branch. Each one of the phase component predistortion unit and the amplitude component predistortion unit may have the structure described above with respect to FIG. 9, for example.

Next, a process for predistorting at least the transmission signal according to an embodiment of the invention will be described with reference to a flow diagram of FIG. 10. The process may be carried out in a radio transmitter according to an embodiment of the invention. The process starts in S1.

In S2, a transmission signal is obtained. The transmission signal may be obtained from a modulation source outputting data symbols to be transmitted from the radio transmitter over an air interface to a radio receiver.

In S3, knowledge of the bandwidth of the transmission signal is obtained. The bandwidth of the transmission signal may be obtained from trans-mission parameters allocated to the radio transmitter, or it may be measured or estimated from the transmission signal. On the basis of at least the bandwidth of the transmission signal, predistortion parameters are selected in S4 for use in predistortion of the transmission signal. The predistortion parameters may include amplitude/envelope predistortion parameters and/or phase predistortion parameters selected from at least one distortion lookup table storing information related to distortion properties of the power amplifier as a function of at least the level of the transmission signal. Furthermore, the predistortion parameters are selected according to the bandwidth of the transmission signal. Additionally, predistortion parameters may be selected for a power supply control signal controlling a power supply signal generator providing the power amplifier with power supply voltage in S4.

In S5, the transmission signal is predistorted by filtering the trans-mission signal according to the predistortion parameters selected in S4. Additionally, the power supply control signal may be predistorted by filtering the power supply control signal according to the predistortion parameters selected for the power supply control signal. Then, the predistorted transmission signal is applied to the power amplifier and is power-amplified in the power amplifier in S6 under the control of the (predistorted) power supply control signal. The process ends in S7.

The embodiments of the invention may be realized in a radio transmitter comprising a processing unit configured to carry out baseband signal processing operations on signals to be transmitted from the radio transmitter. The processing unit may be implemented by an application-specific integrated circuit (ASIC) or by a digital signal processor configured by suitable software. The processing unit may be configured to perform at least some of the steps described in connection with the flowchart of FIG. 10 and in connection with FIGS. 1 to 9. The embodiments may be implemented as a computer program comprising instructions for executing a computer process for predistorting a transmission signal before power amplification.

The computer program may be stored on a computer program distribution medium readable by a computer or a processor. The computer program medium may be for example, but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method, comprising:
obtaining a transmission signal to be power-amplified in a power amplifier prior to transmission;
selecting predistortion parameters for the transmission signal on a basis of knowledge about the bandwidth of the transmission signal; and
predistorting the transmission signal with the selected predistortion parameters before applying the transmission signal to the power amplifier.

2. The method of claim 1, further comprising:
obtaining the knowledge about the bandwidth of the transmission signal from transmission parameters allocated for transmission of the trans-mission signal.

3. The method of claim 1, further comprising:
storing a plurality of signal predistortion lookup tables based on different bandwidths of the transmission signal;
selecting one of the plurality of signal predistortion lookup tables according to the bandwidth of the transmission signal; and
selecting the predistortion parameters from the selected signal pre-distortion lookup table.

4. The method of claim 3, further comprising:
selecting the predistortion parameters from the plurality of signal predistortion lookup tables associated with different bandwidths of the trans-mission signal;
weighting the predistortion parameters selected from the plurality of signal predistortion lookup tables;
combining the weighted predistortion parameters; and
predistorting the transmission signal with the combined predistortion parameters.

5. The method of claim 3, wherein the signal predistortion lookup tables include information related to signal distortion properties of the power amplifier as a function of at least amplitude information of the transmission signal, the method further comprising:
detecting amplitude information of the transmission signal; and
selecting from the selected signal predistortion lookup table predistortion parameters corresponding to the detected amplitude information of the transmission signal.

6. The method of claim 5, wherein the signal distortion lookup tables include amplitude distortion and phase distortion properties of the power amplifier, the method further comprising:
selecting from at least one selected signal predistortion lookup table at least one of envelope predistortion parameters and phase predistortion parameters corresponding to the detected amplitude information of the transmission signal.

7. The method of claim 3, further comprising:
storing each signal predistortion lookup table for a determined range of bandwidths of the transmission signal.

8. The method of claim 1, further comprising:
selecting the predistortion parameters for the transmission signal on the basis of knowledge of the number of frequency resource blocks used for transmission of the transmission signal.

9. The method of claim 8, wherein a transmission resource block includes a predetermined number of subcarriers.

10. The method of claim 1, further comprising:
storing at least one signal predistortion lookup table;
selecting the predistortion parameters from a selected signal predistortion lookup table according to at least one property of the transmission signal; and
scaling the selected predistortion parameters according to the bandwidth of the transmission signal.

11. The method of claim 10, further comprising:
storing a scaling factor lookup table including a plurality of scaling factors associated with different bandwidths or bandwidth ranges of the trans-mission signal;
selecting a scaling factor from the scaling factor lookup table according to the bandwidth of the transmission signal; and
scaling the predistortion parameters with the selected scaling factor.

12. The method of claim 1, further comprising:
predistorting only a phase component of the transmission signal with the selected predistortion parameters before applying the transmission signal to the power amplifier.

13. The method of claim 1, further comprising:
predistorting a power supply control signal used for controlling a power supply signal generator providing the power amplifier with a power supply signal, wherein the power supply control signal is predistorted on the basis of predistortion parameters selected according to the bandwidth of at least one of the signal on the power supply signal line and the transmission signal.

14. An apparatus, comprising:
a predistortion unit configured to obtain a transmission signal to be power-amplified in a power amplifier prior to transmission, to select predistortion parameters for the transmission signal on a basis of knowledge about a bandwidth of the transmission signal, and to predistort the transmission signal with the selected predistortion parameters before outputting the weighted transmission signal for power-amplification.

15. The apparatus of claim 14, wherein the predistortion unit is further configured to obtain the knowledge about the bandwidth of the transmission signal from transmission parameters allocated for transmission of the transmission signal.

16. The apparatus of claim 14, further comprising:
a memory unit configured to store a plurality of signal predistortion lookup tables for different bandwidths of the transmission signal, and the pre-distortion unit is further configured to select one of the plurality of signal predistortion lookup tables according to the bandwidth of the transmission signal and to select the predistortion parameters from the selected signal predistortion lookup table.

17. The apparatus of claim 16, wherein the predistortion unit is further configured to select the predistortion parameters from the plurality of signal predistortion lookup tables associated with different bandwidths of the transmission signal, to weight the predistortion parameters selected from the plurality of signal predistortion lookup tables, to combine the weighted predistortion parameters, and to predistort the transmission signal with the combined predistortion parameters.

18. The apparatus of claim 16, wherein the signal distortion lookup tables include information related to signal distortion properties of the power amplifier as a function of at least amplitude information of the transmission signal, and the predistortion unit is further configured to detect amplitude information of the transmission signal and to select from the selected signal predistortion lookup table predistortion parameters corresponding to the detected amplitude information of the transmission signal.

19. The apparatus of claim 18, wherein the signal distortion lookup tables include amplitude distortion and phase distortion properties of the power amplifier, and the predistortion unit is further configured to select from at least one selected signal predistortion lookup table at least one of envelope predistortion parameters and phase predistortion parameters corresponding to the detected amplitude information of the transmission signal.

20. The apparatus of claim 16, wherein the memory unit is further configured to store each signal predistortion lookup table for a determined range of bandwidths of the transmission signal.

21. The apparatus of claim 14, wherein the predistortion unit is further configured to select the predistortion parameters for the transmission signal on the basis of knowledge on the number of frequency resource blocks used for transmission of the transmission signal.

22. The apparatus of claim 21, wherein a transmission resource block includes a predetermined number of subcarriers.

23. The apparatus of claim 14, further comprising:
a memory unit configured to store at least one signal predistortion lookup table, and the predistortion unit is further configured to select the pre-distortion parameters from a selected signal predistortion lookup table according to at least one property of the transmission signal and to scale the selected predistortion parameters according to the bandwidth of the transmission signal.

24. The apparatus of claim 23, wherein the memory unit is further configured to store a scaling factor lookup table including a plurality of scaling factors associated with different bandwidths or bandwidth ranges of the trans-mission signal, and the predistortion unit is further configured to select a scaling factor from the scaling factor lookup table according to the bandwidth of the transmission signal and to scale the predistortion parameters with the selected scaling factor.

25. The apparatus of claim 14, wherein the predistortion unit is further configured to predistort only a phase component of the transmission signal with the selected predistortion parameters before applying the transmission signal to the power amplifier.

26. The apparatus of claim 14, wherein the predistortion unit is further configured to predistort a power supply control signal used for controlling a power supply signal generator providing the power amplifier with a power supply signal, wherein the power supply control signal is predistorted on the basis of predistortion parameters selected according to the bandwidth of at least one of the signal on the power supply signal line and the transmission signal.

27. A radio transmitter comprising:
a predistortion unit comprising a processing unit configured to obtain a transmission signal to be power-amplified in a power amplifier prior to transmission, to select predistortion parameters for the transmission signal on the basis of knowledge about the bandwidth of the transmission signal, and to pre-distort the transmission signal with the selected predistortion parameters; and
a power amplifier configured to power-amplify the predistorted trans-mission signal.

28. An apparatus, comprising:
obtaining means for obtaining a transmission signal to be power-amplified in a power amplifier prior to transmission;
selecting means for selecting predistortion parameters for the trans-mission signal on the basis of knowledge about the bandwidth of the transmission signal; and
predistorting means for predistorting the transmission signal with the selected predistortion parameters before applying the transmission signal to the power amplifier.

29. A computer-readable program distribution medium encoding a computer program of instructions being configured to control a processor to perform:
obtaining a transmission signal to be power-amplified in a power amplifier prior to transmission;
selecting predistortion parameters for the transmission signal on a basis of knowledge about a bandwidth of the transmission signal; and
predistorting the transmission signal with the selected predistortion parameters before applying the transmission signal to the power amplifier.
